(19) United States
(12) Patent Application Publication
(10) Pub. No.: US 2013/0256199 A1
(43) Pub. Date: Oct. 3, 2013

(54) SCREENING MACHINE FOR SCREENING OR REFINING GRAVEL, SAND OR THE LIKE

(71) Applicant: Burkhard SCHMITT, Birkenau (DE)

(72) Inventor: Burkhard SCHMITT, Birkenau (DE)

(21) Appl. No.: 13/656,971

(22) Filed: Oct. 22, 2012

(30) Foreign Application Priority Data
Mar. 30, 2012 (DE) 20 2012 003 315.8

(51) Int. Cl. B07B 1/28; B07B 1/42

(52) U.S. Cl. 209/235

(57) ABSTRACT

Disclosed is a screening machine for screening, preparing, or refining gravel, sand or other bulk material, including a machine body, a drive, operatively linked to the machine body, for generating a shaking and/or swinging motion, and at least one air bellows supporting the screening machine.

### CROSS-REFERENCE TO RELATED PATENT APPLICATIONS

This application is based upon and claims the benefit of priority from prior German Patent Application No. DE 20 2012 003 315.8, filed Mar. 30, 2012, the entire contents of which are incorporated herein by reference.

### BACKGROUND

Embodiments of the invention of the present application relate to a screening machine for screening, preparing or refining gravel, sand or other bulk material with a drive for generating a shaking and/or swinging motion, wherein the screening machine is supported on at least one air bellows.

Screening machines are used in materials preparation technology for example for separating stones, sand or earth mechanically according to particle size, and produce specific grain size distributions. Such screening machines are therefore also called classifiers.

But screening machines are also used for purifying gravel or sand contaminated with other organic substances such as for example wood, coal or the like. Such screening machines comprise a recipient which is put in shaking motion by means of a drive. By shaking and/or swinging motions, the raw material moves from the feed end to the outlet or discharge with it optionally also being purified by the addition of water.

Moreover, screening machines may also be used for drying bulk material, such as for example, sand. In such screening machines, the bulk material may also be conveyed from a feed end to an outlet or discharge end by a shaking and/or swinging motion with the water which is contained in the bulk material being separated out.

The shaking motion and/or oscillations occurring in a screening machine generally reach an amplitude varying between 8 mm and 20 mm at an acceleration of up to 6 g. In order to dampen such oscillations, leaf springs, helical compression springs or rubber cushions are used. For screening machines, in more than 95% of the cases helical compression springs are used. But helical compression springs have the disadvantage that the inclination of the screening machine is not adjustable. Moreover, helical springs must be enclosed in order to prevent accidents.

Moreover, known screening machines with helical compression springs require an additional brake, which decelerates strong oscillations occurring in particular after shutdown of the screening machine, and thus prevent a too strong oscillation and damages. With the usual helical compression springs sufficient damping is not possible. The result is an increased noise development, possible fracture by vibration on the railing, on power cables or ducts as well as damage to the machine itself.

### SUMMARY OF PREFERRED EMBODIMENTS

Therefore, an object of an embodiment of the present invention is to provide a screening machine with improved damping with respect to the sub-structure and the environment, thus generating considerably less oscillations and background noises.

This object may be solved according to an embodiment of the invention, e.g. by a screening machine for screening, preparing, or refining gravel, sand or other bulk material, with a machine body, a drive, operatively linked to the machine body, for generating a shaking motion, wherein the screening machine is supported on at least one air bellows.

According to this embodiment of the invention it is suggested to mount the screening machine on at least one air bellows. Compared with helical compression springs, air bellows have far better damping properties, and can therefore remedy the above mentioned drawbacks of helical compression springs.

The air bellows according to yet another embodiment of the invention is/are preferably arranged such that they substantially absorb the forces acting in vertical direction.

The air bellows according to still another embodiment of the invention can be formed in principle either as single, double or multiple bellows.

In the case of screening machines mounted on several air bellows, the individual bearings can be configured differently. Thus, the number or type of air bellows can be different from bearing to bearing. One bearing, for example, can comprise two air bellows, another only one air bellows. One bearing, for example, can also comprise double air bellows whereas another bearing comprises only single air bellows.

Preferably, the air bellows is/are connected to a pressure source. This has the advantage that the pressure existing in the air bellows can be modified also during operation of the screening machine. Hence, it is possible to increase or decrease damping of at least one air bellows during operation, to adjust the working height of the screening machine or to modify the inclination of the screening machine. Alternatively, the screening machine height could also be kept constant on a support point even if the weight in this point increases or decreases during operation. Corresponding pressure adjustment can either be made automatically or manually.

According to another preferred embodiment of the invention, the screening machine comprises a management or control system by means of which the pressure in at least one air bellows is automatically adjustable during operation of the machine. In the case of a screening machine with several air bellows, pressure may preferably adjustable individually or in groups. In the latter case, for example the air bellows on one side of the screening machine (e.g. the feed end) and the air bellows on a second side (e.g. outlet or discharge) can each be jointly put under pressure.

The air bellows can, for example, be filled with air or with another gas.

According to another preferred embodiment of the invention, the screening machine comprises several air bellows which with respect to a central cross-sectional plane of the screening machine are arranged on different sides of the screening machine.

According to still another preferred embodiment, the screening machine is preferably supported on air bellows in at least four points.

In the case of a screening machine with several air bellows, these may preferably be arranged on the two longitudinal sides of the screening machine, with the air bellows being preferably arranged symmetrically with respect to a longitudinal central axis.

A screening machine according to another embodiment of the invention may comprise at least one lateral guide limiting movement of the screening machine in lateral direction.

According to still another preferred embodiment of the invention, lateral guides are provided on both longitudinal sides of the screening machine.

Since the screening machine according to various embodiments of the invention may be mounted on one or several air bellows, an additional brake as it is usual for screening machines with helical compression springs is no longer necessary.

Further objects, features, and advantages of the invention will become apparent from the detailed description of preferred embodiments that follows, when considered together with the accompanying drawings.

### BRIEF DESCRIPTION OF THE DRAWINGS

Preferred embodiments of the invention are explained in detail below in connection with the attached drawings in which:

FIG. 1 is a side view of a screening machine mounted on air bellows;

FIG. 2a is a cross-sectional view of the screening machine of FIG. 1 in a first position;

FIG. 2b is a partial sectional view of the screening machine of FIG. 1 in a second position; and

FIG. 3 is a schematic view of a management or control system for adjusting the pressure in the air bellows.

### DETAILED DESCRIPTION OF PREFERRED EMBODIMENTS

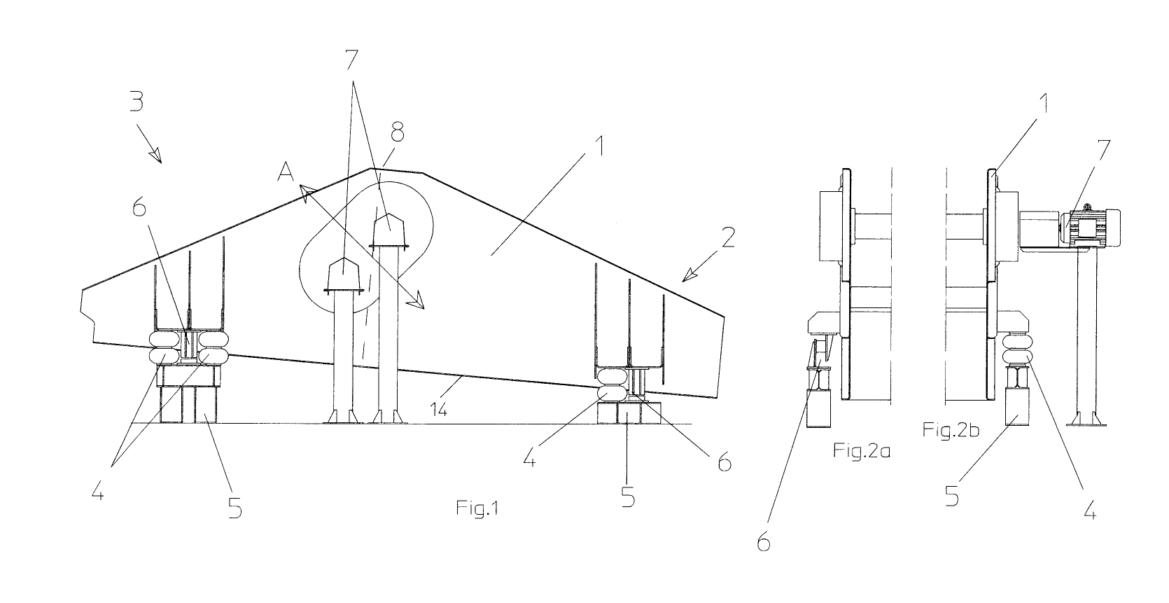

FIG. 1 shows a side view of an exemplary screening machine 1 for the drainage of sand. The screening machine 1 comprises a machine body 14 which is inclined to the horizontal by a given angle such as e.g. 3° to 5°. The machine body 14 is driven by a drive 7 which in the example shown comprises two electric motors and which generates a shaking and/or swinging motion in the direction of arrow A. The direction of the shaking and/or swinging motion is in an angle of approx. 45° to the horizontal.

The exemplary screening machine 1 shown has a feed side 2 where the feedstock such as e.g. sand is introduced into the machine body 14. Driven by the shaking motion, the feedstock on the bottom of the machine body 14 moves towards the top in the direction of the outlet or discharge 3. During transport of the bulk material in the direction of the outlet or discharge 3, it loses water and thus becomes drier. The partially dried bulk material is then discharged at the outlet.

The screening machine shown in FIG. 1 is supported on air bellows 4 in four points in total. But more or fewer bearings 4, 5 could be provided. In the embodiment shown, two bearings 4, 5 are located on each longitudinal side of the machine body 14 with one bearing each being arranged on the feed side 2 and one bearing on the outlet or discharge 3. The bearings 4, 5 are preferably symmetric with respect to a central longitudinal sectional plane. On the feed side 2 and the outlet or discharge 3, the bearings 4, 5 have different dimensions. Since the weight of the bulk material on the outlet or discharge 3 is greater than on the feed side 2, the bearings 4, 5 are here larger than on the feed side 2.

Each bearing 4, 5 comprises at least one air bellows 4, which dampens the forces occurring during operation of the screening machine 1, as well as a spring carrier 5 on which the air bellows 4 are placed. One double air bellows 4 each is provided on the feed side 2 on both longitudinal sides of the machine body 14. On the outlet or discharge 3, however, two adjacent double air bellows are located on each longitudinal side of the machine body 14. Moreover, a lateral guide 6 is provided on each bearing 4, 5 which is shown still more clearly in FIG. 2a. The lateral guide 6 substantially comprises a guide part formed on the machine body 14, which guide part is guided alongside a lateral stop provided on the spring carrier 5, and which stop limits oscillation of the screening machine 1 in lateral direction.

In the event of an air leak in one of the air bellows 4, the screening machine 1 bears on a spring carrier 5.

FIG. 2b shows a cross-sectional view of another part of the screening machine 1 with the drive 7 and a bearing 4, 5 with one double air bellows 4. In that case, the drive 7 comprises two electric motors driving the machine body 14, thus creating a linear movement in the direction of the arrow A (see FIG. 1).

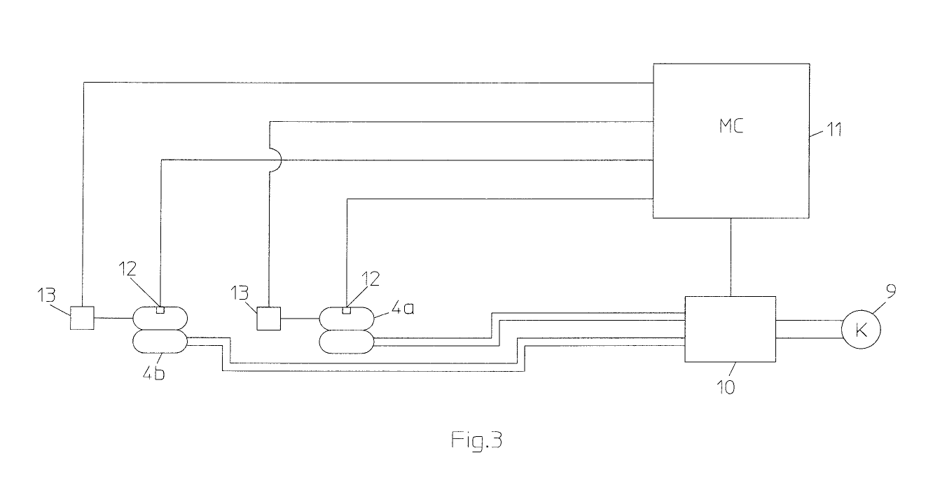

FIG. 3 is a schematic view of a management or control device for adjusting the air pressure in the air bellows 4a, 4b. The device comprises an air pressure source 9, such as for example a compressor, which can be connected via valves 10 to one or several of the air bellows 4a, 4b. In the embodiment shown, the air bellows 4a, 4b are firmly connected to the air pressure source 9. Alternatively they could also be connected to an air pressure source 9 only if required.

After mounting of the air bellows, these are inflated up to a required working height by means of compressed air. The working height can be different on the feed side 2 compared with the outlet or discharge 3 of the screening machine 1. By selection of the air pressure, on the one hand the working height and on the other hand also inclination of the screening machine 1 can be varied.

The exemplary device shown in FIG. 3 comprises a control unit 11 with a management or control software by means of which the pressure existing in the air bellows 4a, 4b can be automatically varied during operation of the machine 1. Thus, e.g. it is possible to automatically increase, decrease or keep constant the damping of at least one air bellows 4 during operation, to adjust or keep constant the working height of the screening machine 1 or to vary and/or keep constant the inclination of the screening machine 1. Hence, e.g. the working height of the screening machine 1 could be kept constant in at least one support point even if the weight in this point increases or decreases during operation.

In order to fill the air bellows 4a, 4b, the valves 10 are opened accordingly by the control unit and closed again when a target pressure is reached. For this purpose, the valves 10 can be controlled by the control unit 11 via control lines. The pressure existing in the air bellows 4a, 4b is measured by means of a manometer 12 the measured data of which are evaluated by the control unit 11. If necessary, air can also be removed again from the air bellows 4a, 4b. For this purpose, exhaust valves 13 are provided which can be controlled accordingly by the control unit 11.

Thus, with the exemplary device shown in FIG. 3 it is possible to automatically adjust the air pressure in the individual air bellows 4a, 4b during operation of the screening machine. According to the embodiment, the air bellows can be put under pressure individually or in groups or pressure can be reduced. The air bellows on one side (e.g. the feed side 2 or the outlet or discharge 3) are preferably connected to a common compressed air circuit and are inflated to the same air pressure. But alternatively each air bellows 4 could be individually put under pressure. In that case each air bellows 4 would require e.g. an own shut-off valve 10 or, if necessary, also an own air pressure source 9.

The foregoing embodiments have been shown for illustrative purposes only and are not intended to limit the scope of the invention which is defined by the claims.

What is claimed is:

1. A screening machine for screening, preparing, or refining gravel, sand or other bulk material, comprising:
a machine body,
a drive, operatively linked to the machine body, for generating a shaking and/or swinging motion, and
at least one air bellows supporting the screening machine.

2. The screening machine according to claim 1, wherein the at least one air bellows is arranged such that it substantially absorbs the forces acting in vertical direction.

3. The screening machine according to claim 1 wherein a plurality air bellows are provided which, with respect to a central sectional plane of the screening machine, are located on different sides of the screening machine.

4. The screening machine according to claim 1, further comprising a device for filling the air bellows, by which the pressure in the individual air bellows can be adjusted in different amounts.

5. The screening machine according to claim 1, wherein the screening machine is supported on several air bellows, with the air bellows being arranged symmetrically on both longitudinal sides of the screening machine.

6. The screening machine according to claim 1, wherein at least one air bellows is formed as a single, double or multiple bellows.

7. The screening machine according to claim 1, wherein the screening machine comprises a management or control system by which the pressure in at least one air bellows can be automatically varied during operation of the screening machine.

8. The screening machine according to claim 1, further comprising, on both longitudinal sides of the screening machine, a lateral guide.

9. The screening machine according to claim 1, wherein the screening machine does not comprise a brake for slowing down the screening machine.

10. The screening machine according to claim 2 wherein a plurality air bellows are provided which, with respect to a central sectional plane of the screening machine, are located on different sides of the screening machine.

11. The screening machine according to claim 2, further comprising a device for filling the air bellows, by which the pressure in the individual air bellows can be adjusted in different amounts.

12. The screening machine according to claim 10, further comprising a device for filling the air bellows, by which the pressure in the individual air bellows can be adjusted in different amounts.

13. The screening machine according to claim 2, wherein the screening machine is supported on several air bellows, with the air bellows being arranged symmetrically on both longitudinal sides of the screening machine.

14. The screening machine according to claim 13, further comprising a device for filling the air bellows, by which the pressure in the individual air bellows can be adjusted in different amounts.

15. The screening machine according to claim 2, wherein at least one air bellows is formed as a single, double or multiple bellows.

16. The screening machine according to claim 3, wherein at least one air bellows is formed as a single, double or multiple bellows.

17. The screening machine according to claim 4, wherein at least one air bellows is formed as a single, double or multiple bellows.

18. The screening machine according to claim 5, wherein at least one air bellows is formed as a single, double or multiple bellows.

19. The screening machine according to claim 10, wherein at least one air bellows is formed as a single, double or multiple bellows.

20. The screening machine according to claim 12, wherein at least one air bellows is formed as a single, double or multiple bellows.

21. The screening machine according to claim 13, wherein at least one air bellows is formed as a single, double or multiple bellows.

22. The screening machine according to claim 14, wherein at least one air bellows is formed as a single, double or multiple bellows.
